(19) United States
(12) Patent Application Publication
(10) Pub. No.: US 2025/0377048 A1
(43) Pub. Date: Dec. 11, 2025

(54) Butterfly Valve Housing Assembly

(71) Applicant: Georg Fisher Rohrleitungssysteme AG, Schaffhausen (CH)

(72) Inventors: Maxim WASETZKI, Singen (DE); Lars Mayer, Allensbach (DE); Richard Rech, Donaueschingen (DE); Fabian Neubrand, Welchingen (DE)

(21) Appl. No.: 19/233,321

(22) Filed: Jun. 10, 2025

(30) Foreign Application Priority Data
Jun. 11, 2024 (EP) 24181421.9

(51) Int. Cl. F16K 27/02; F16K 1/22

(52) U.S. Cl. CPC F16K 27/0218; F16K 1/221

(57) ABSTRACT

A butterfly valve housing assembly for a butterfly valve having a closing element mounted in the housing so as to be rotatable about a vertically extending stem, comprising a housing consisting of plastic or light alloy, a vertically extending stem, a through-flow opening, arranged in the housing, accommodating the closing element, and flanges arranged at the ends, wherein at least one reinforcing element is arranged in the housing, which reinforcing element is connected to the flanges by means of force-absorbing means in such a way that internal pressure forces acting on the stem are absorbed by the force-absorbing means via the reinforcing element.

### CROSS-REFERENCE TO RELATED APPLICATIONS

This application claims the benefit and priority of European Patent Application No. 24181421.9 filed Jun. 11, 2024. The entire disclosure of the above application is incorporated herein by reference.

### BACKGROUND OF THE INVENTION

### Technical Field

The invention relates to a butterfly valve housing assembly for a butterfly valve having a closing element mounted in the housing so as to be rotatable about a vertically extending stem, comprising a housing consisting of plastic or light alloy, a vertically extending stem, a through-flow opening, arranged in the housing, accommodating the closing element, and flanges arranged at the ends.

### Discussion

In pipeline construction, butterfly valves are employed in order to close or regulate the flow through pipelines carrying liquid or gaseous media. For this purpose, it is important that the butterfly valve, in particular the housing, can withstand the internal pressures that occur when the butterfly is closed for a long time and for a large number of actuating cycles. Owing to the high pressure on the disc in the closed state, the stem bends and presses on the housing, and, in the case of plastic housings and high pressures and thus high effective forces, this can quickly lead to failure, thereby potentially giving rise to stress cracks.

Butterfly valves made of plastic therefore often have a reinforcing ring, which is embedded in the housing and surrounds the stem. Although the housing is then reinforced at this location, the pressures are nevertheless transferred to the plastic housing, which does not have sufficient strength for such high forces.

EP 4 191 100 A1 discloses a reinforcing sleeve in the housing neck. Nevertheless, the housing must absorb the internal pressure forces when the butterfly valve is closed, and this can therefore quickly lead to failure in the case of a plastic housing.

It is an aspect of the invention to propose a butterfly valve housing assembly which has a housing made of plastic or light alloy and which withstands the permitted pressures as per the pipelines to be connected.

This aspect is achieved by virtue of the fact that at least one reinforcing element is arranged in the housing, which reinforcing element is connected to the flanges by means of force-absorbing means in such a way that internal pressure forces acting on the stem are absorbed by the force-absorbing means via the reinforcing element.

The butterfly valve housing assembly according to the preferred embodiment of the invention for a butterfly valve having a closing element mounted in the housing so as to be rotatable about a vertically extending stem, comprises a housing consisting of plastic or light alloy. The housing is preferably of slim construction. The butterfly valve housing assembly according to the invention comprises a stem extending vertically through the housing. In addition, the butterfly valve housing assembly according to the invention comprises a through-flow opening, arranged in the housing, accommodating the closing element, with the through-flow opening preferably being of circular design. There are flanges arranged at the ends of the butterfly valve housing assembly according to the invention. It is advantageous if the flanges are designed as separate parts, it being possible to use loose flanges or, alternatively, fixed flanges. The flanges are preferably formed from a high-strength material such as a metallic material, preferably steel or cast iron, or a glass-fibre-reinforced material. At least one reinforcing element is arranged in the housing of the butterfly valve housing assembly according to the invention. It serves to absorb the force which acts on the stem on account of the pressure acting on the closing element when the butterfly valve is closed, and to transfer said force to force-absorbing means, rather than the force acting on the housing made of plastic or light alloy. For this purpose, the reinforcing element is connected to force-absorbing means, preferably being connected to one another directly and rigidly, wherein the force-absorbing means, in turn, are connected to the flanges arranged at the ends in such a way that internal pressure forces acting on the stem are absorbed by the force-absorbing means via the reinforcing element. It is advantageous if the force-absorbing means are connected firmly to the flanges and the reinforcing element.

The housing is preferably of single- or two-part design. In the case of a two-part housing, the parting plane preferably extends at right angles to the flow direction, and the two housing halves, which are preferably of the same design, are connected to one another by the reinforcing element arranged between them. In the case of a single-part housing, the reinforcing element is preferably inserted into the mould and overmoulded or encapsulated with the material of the housing.

It is advantageous if the reinforcing element is surrounded by the plastic or light alloy of the housing. The reinforcing element is preferably completely surrounded by the plastic or light alloy of the housing and embedded therein. The stem preferably extends through the reinforcing element, which is arranged in the housing. It is advantageous if the reinforcing element has a through-hole situated in the centre, which extends in a vertical direction or at right angles to the flow direction and is passed through by the stem. On the outer surfaces, the reinforcing element preferably has a rib structure to ensure that the reinforcing element bonds firmly and over a large surface area with the plastic housing or light alloy housing, since optimum form-locking engagement is achieved by means of the rib structure.

The vertical stem is preferably of single- or multi-part design, preferably being of two-part design. The stem is preferably designed in such a way that it passes continuously as a single-part stem through the entire closing element from the upper to the lower housing region, or the stem is preferably of two-part design, wherein the upper part of the stem is arranged in the upper housing region and projects into the closing element but is not continuous, and the second part of the stem is arranged in the lower housing part and projects from below into the closing element.

It is advantageous if the vertically extending stem extends through a reinforcing element arranged in the upper region of the housing and through a reinforcing element, arranged diametrically opposite thereto, in the lower region of the housing. It is advantageous if the mounting of the stem in the housing takes place above and below the respective reinforcing element, for which purpose bearing bushes are preferably arranged in the housing. For this purpose, as already mentioned, the stem can be of single-part or two-part design.

It has been found to be a preferred embodiment if the reinforcing element is made of a high-strength material, preferably a material which has a higher strength than the surrounding plastic or the surrounding light alloy of the housing. There is a special preference for metallic materials, e.g. steel or cast iron, or glass-fibre-reinforced materials or plastics or composite materials, which are well suited for use as reinforcing elements.

It has been found advantageous if the reinforcing element is designed as a ring segment and is arranged concentrically with the through-flow opening in the housing. A reinforcing element is preferably arranged vertically above the through-flow opening, and the second reinforcing element is arranged diametrically opposite thereto in the lower region of the housing. It is advantageous if the ring segment extends over an angle of at least 20°. The ring segment preferably extends over 30 to 120°.

It is advantageous if the reinforcing elements arranged in the housing are of the same or identical design.

It has been found advantageous if the reinforcing element is of mirror-symmetrical design, preferably along the extension of the stem.

The two flanges arranged at each end of the housing are preferably connected firmly to the reinforcing elements by means of the force-absorbing means. It is advantageous if the force-absorbing means rest against the outer supporting surfaces of the flanges. In this case, connecting means such as screws can preferably be employed as force-absorbing means. The force-absorbing means extend from the two flanges in the direction of the housing situated in between and are connected firmly to the reinforcing element.

It is advantageous if the force-absorbing means are in each case arranged on both sides of the stem, this ensuring symmetrical force transmission, with the result that the force acting on the stem is directed into the reinforcing element to the force-absorbing means. Both in the flow direction and also horizontally, the force-absorbing means are preferably arranged at right angles to the flow direction on both sides of the stem.

All the embodiment possibilities can be freely combined with one another.

An exemplary embodiment of the invention is described with reference to the figures, wherein the invention is not restricted only to the exemplary embodiment. In the drawings:

### BRIEF DESCRIPTION OF THE DRAWINGS

FIG. 1 shows a three-dimensional sectional view through a butterfly valve housing assembly according to the invention having a two-part stem,

FIG. 2 shows a three-dimensional sectional view through a butterfly valve housing assembly according to the invention having a single-part stem,

FIG. 3 shows a three-dimensional sectional view through two mutually opposite force-absorbing means in the upper housing region,

FIG. 4 shows a three-dimensional longitudinal section through a butterfly valve housing assembly according to the invention,

FIG. 5 shows a three-dimensional view of a butterfly valve housing assembly according to the invention,

FIG. 6a shows a three-dimensional view of the upper and lower reinforcing elements with the force-absorbing means,

FIG. 6b shows a three-dimensional view of the upper and lower reinforcing elements with the force-absorbing means,

FIG. 7 shows a horizontal partial section through the upper reinforcing element.

### DESCRIPTION OF THE PREFERRED EMBODIMENTS OF THE INVENTION

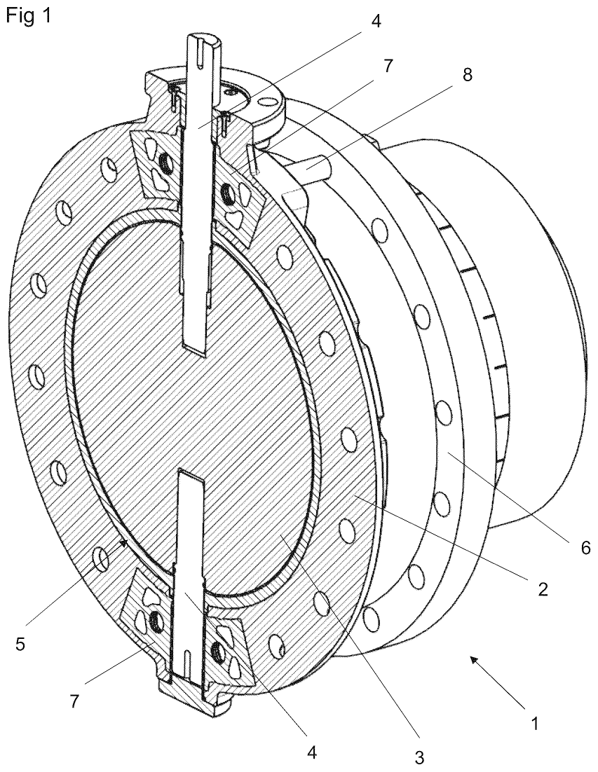

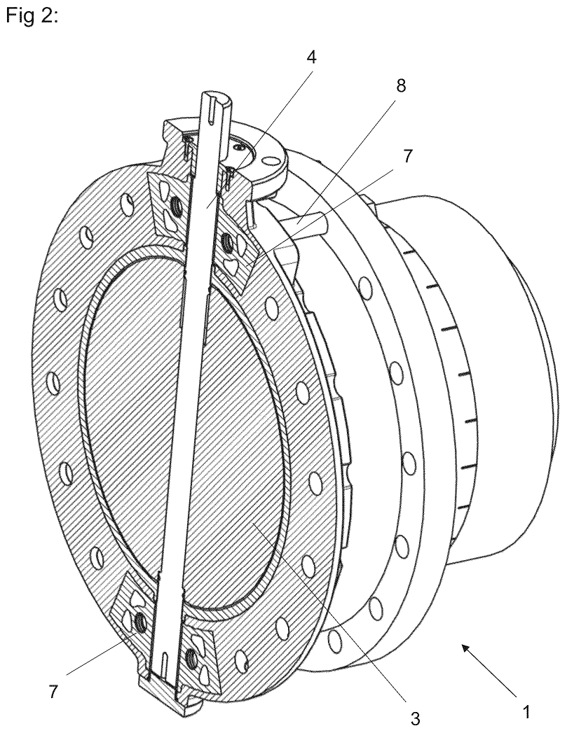

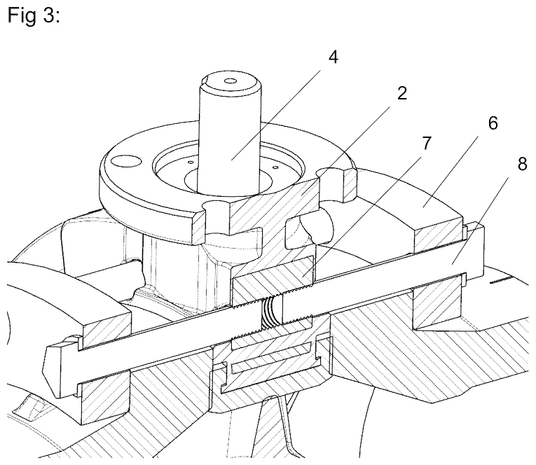

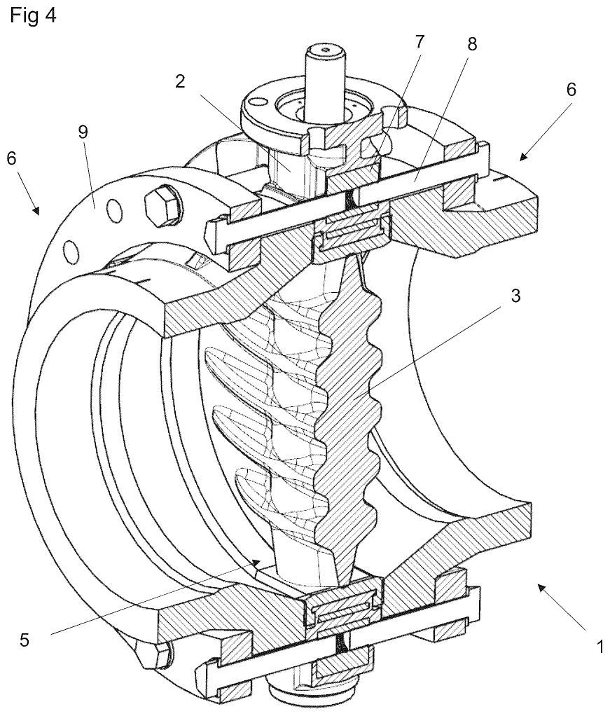

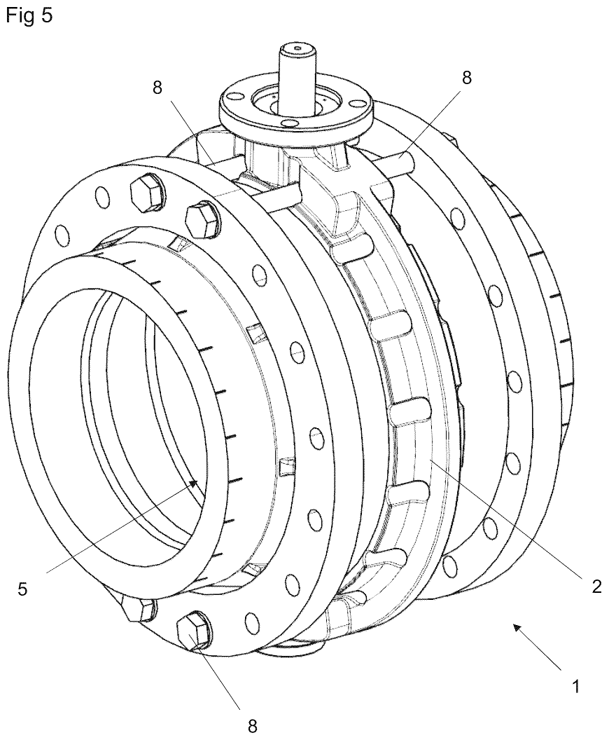

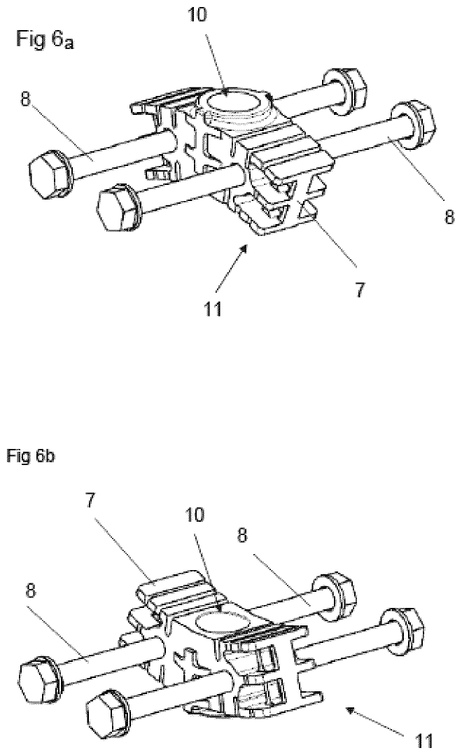

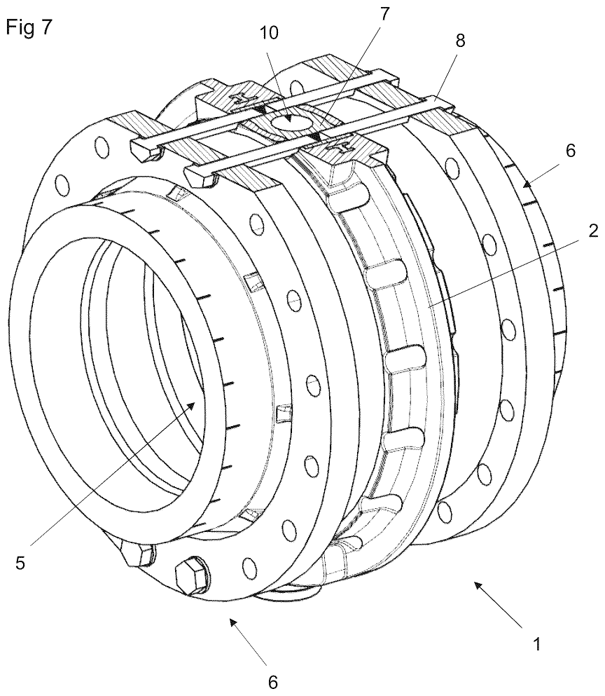

The drawing illustrated in FIG. 1 shows a butterfly valve housing assembly 1 according to the invention for a butterfly valve with a closing element 3 mounted rotatably in the housing 2. The housing 2 is produced from plastic or light alloy. A vertically extending stem 4 is arranged in the housing 2, wherein the stem 4 is designed as a single-part stem 4, as illustrated in FIG. 2, or as a multi-part, preferably two-part, stem 4 as illustrated in FIG. 1. The housing 2 has a through-flow opening 5, in which a closing element 3 is arranged. Arranged at each end of the housing 2 are flanges 6, wherein the flanges 6 can be designed as loose or fixed flanges. In the figures, loose flanges 6 are depicted, and it is also possible to replace these by fixed flanges, as mentioned. It is advantageous if the flanges 6 are produced from a metallic material or a reinforced plastic. The flanges 6 are assembled with the housing 2 in between by means of fastening means (not illustrated). At least one reinforcing element 7 is arranged in the plastic housing 2. At least two reinforcing elements 7, one in the upper and one in the lower housing region respectively, are preferably arranged, and the stem 4 projects through them. The reinforcing element 7 is connected to the flanges 6 by means of force-absorbing means 8 in such a way that internal pressure forces acting on the stem 4 are absorbed by the force-absorbing means 8 via the reinforcing element 7 while a butterfly valve is closed. That is to say that the pressure forces that act on the stem 4 are absorbed by the reinforcing element 7 and transferred to the force-absorbing means 8, which are connected to the flanges 6 and, as a result, form a stable arrangement. It is clearly apparent in FIGS. 3 and 4 that the force-absorbing means 8 rest against the outer supporting surfaces 9 of the flanges 6 and project into the reinforcing element 7 or are connected thereto and form a rigid unit. The force-absorbing means 8 are preferably arranged parallel to the through-flow direction. It is clearly apparent in FIGS. 1 and 2 as well as 7 that the reinforcing element 7 is completely surrounded by the housing 2 or the plastic or light alloy thereof. It is advantageous if the reinforcing elements 7 are arranged diametrically and concentrically around the through-flow opening 5 or in the flow direction with respect to the longitudinal axis. It is preferable if the reinforcing elements 7 arranged in the housing 2 are of the same design. In FIG. 6, the two reinforcing elements 7 arranged diametrically in the housing 2 are shown with the force-absorbing means 8 without a surrounding housing 2. On the outer surface, the reinforcing element 7 preferably has a rib structure 11, thereby creating a large surface area and ensuring good bonding into the housing 2. The force-absorbing means 8 are preferably designed as screws, although it is also possible to employ other force-absorbing means 8 that are firmly connected to the reinforcing element 7 and rest against the outer supporting surfaces 9 of the flanges 6, thereby absorbing the force acting on the stem 4, ensuring that the plastic or light alloy housing 2 is not stressed. It is advantageous if the reinforcing element 7 is made of a high-strength material, preferably a material which has a higher strength than the surrounding plastic or the surrounding light alloy of the housing 2. As a special preference, the reinforcing element 7 consists of a metallic material, e.g. steel or cast iron or a glass-fibre-reinforced plastic. It is advantageous, as is clearly apparent from FIGS. 1 and 2 as well as 7, if the reinforcing element 7 is designed as a ring segment. This enables it to be embedded in an optimum manner into the housing 2, ensuring that it is arranged concentrically around the through-flow opening 5. The ring segment preferably extends over an angle of from 30 to 120°. As a preferred option, one reinforcing element 7 is arranged vertically above and one vertically below the through-flow opening 5, and therefore the vertically extending stem 4 extends through the through-hole 10 in the reinforcing elements 7. The force-absorbing means 8 are arranged on both sides of the stem 4 to ensure uniform force distribution. It is advantageous if the force-absorbing means 8 are each arranged at the same distance to the left and right of the stem 4 both in the flow direction and at right angles to the flow direction, this being clearly apparent from FIG. 7.

What is claimed is:

1. A butterfly valve housing assembly (1) for a butterfly valve having a closing element (3) mounted in the housing (2) so as to be rotatable about a vertically extending stem (4), comprising a housing (2) consisting of plastic or light alloy, a vertically extending stem (4), a through-flow opening (5), arranged in the housing, accommodating the closing element (3), and flanges (6) arranged at the ends, characterized In that at least one reinforcing element (7) is arranged in the housing (2), which reinforcing element is connected to the flanges (6) by means of force-absorbing means (8) in such a way that internal pressure forces acting on the stem (4) are absorbed by the force-absorbing means (8) via the reinforcing element (7).

2. A butterfly valve housing assembly (1) according to claim 1, wherein the housing (2) is of single- or two-part design.

3. A butterfly valve housing assembly (1) according to claim 1, wherein the reinforcing element (7) is surrounded by the plastic or light alloy of the housing (2).

4. A butterfly valve housing assembly (1) according to claim 1, characterized in that the vertical stem (4) is of single- or multi-part design.

5. A butterfly valve housing assembly (1) according to claim 1, wherein the vertically extending stem (4) extends through a reinforcing element (7) arranged in the upper region of the housing (2) and through a reinforcing element (7), arranged diametrically opposite thereto, in the lower region of the housing.

6. A butterfly valve housing assembly (1) according to claim 1, wherein the reinforcing element (7) is made of a high-strength material, preferably a material which has a higher strength than the surrounding material of the housing (2), more specifically preferably a metallic material, preferably steel or cast iron, or a glass-fibre-reinforced material or a composite material.

7. A butterfly valve housing assembly (1) according to claim 1, wherein the reinforcing element (7) is designed as a ring segment and is arranged concentrically with the through-flow opening (5) in the housing (2).

8. A butterfly valve housing assembly (1) according to claim 1, wherein the two flanges (6) arranged at each end of the housing (2) are connected firmly to the reinforcing elements (7) by means of the force-absorbing means (8).

9. A butterfly valve housing assembly (1) according to claim 1, wherein the force-absorbing means (8) are in each case arranged on both sides of the stem (4).

10. A butterfly valve housing assembly (1) according to claim 1, the reinforcing elements (7) arranged in the housing (2) are of the same design.

11. A butterfly valve housing assembly (1) according to claim 1, the reinforcing element (7) is of mirror-symmetrical design.
